(19) United States
(12) Patent Application Publication
(10) Pub. No.: US 2007/0077984 A1
(43) Pub. Date: Apr. 5, 2007

(54) GAMING MACHINE AND SYSTEM COMPRISING ELECTRONIC PAPER

(75) Inventors: Eiji AIDA, Zama city (JP); Toshiaki SHIMIZU, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/419,204

(22) Filed: May 19, 2006

(30) Foreign Application Priority Data
Sep. 30, 2005 (JP) 2005-286213

(51) Int. Cl. A63F 13/00

(52) U.S. Cl. 463/20

(57) ABSTRACT

A first communications unit of a display control unit exchanges commands with a second communications unit of a display unit, and thereby establishes a connection between the two communications units. In the display control unit, a communication managing unit compares the commands exchanged between the two communications units against valid or invalid commands stored in a command storage unit, and then accepts or rejects the connection between the two communications units based on the comparison, respectively. Furthermore, an encryption unit encrypts image data stored in a data storage unit, and the first communications unit repeatedly transfers the same image data at predetermined intervals. In the display unit, a decoding unit decodes data received by the second communications unit into image data, and then provides the image data to electronic paper. Images which correspond to the image data are reproduced on the electronic paper.

### CROSS-REFERENCE TO RELATED APPLICATIONS

This application claims priority to Japanese Patent Application No. 2005-286213. The entire disclosure of Japanese Patent Application No. 2005-286213 is hereby incorporated herein by reference.

### BACKGROUND OF THE INVENTION

1. Field of the invention

The present invention relates to a gaming machine, and in particular, a machine that comprises electronic paper serving as a display device.

2. Background Information

The variety in gaming machines is quite wide, and extends from large arcade game machines to home and portable video game machines. In addition, the functions of game machines have been integrated into other devices, such as a beverage vending machine having a roulette-like function.

Gaming machines in general are equipped with a CPU that is used for game control. For example, a video machine displays game output in graphic form on a screen. Alternatively, for example, a crane game machine controls the movement of its arms with high precision, and slot machines perform lottery operations.

Recently, the performance of the CPU mounted in gaming machines has been remarkably improved. Thus, the games themselves have been further improved in variety and complexity. In addition, visual or sound effects in games and the operability of a user interface have been further improved. For example, display devices are installed in control panels, cabinets, and the like, of gaming machines, and the gaming machines can change their displays depending on the type of game being played. Thus, the enjoyment of the game and the operability of the machine are further enhanced. Furthermore, when the appearances of control panels and cabinets of such gaming machines, such as decorations and lettering, are to be changed because of model changes, the gaming machines require only a renewal of image data to be provided to the above-described display devices in addition to a renewal of game programs. In particular, portions of the control panels and the cabinets do not need to be replaced. Accordingly, the above-described gaming machines are suitable for use in areas where several gaming machines are managed where model changes frequently occur, such as in arcades and casinos.

Conventional gaming machines which use electronic paper as display devices are disclosed in, for example, Japan Published Patent Application Nos. 2004-121626 and 2005-000475. These machines are referred to as “pachislot” machines, and use electronic paper in order to display symbols on stepper reels, and to display pay tables on the face of cabinet, respectively. Electronic paper has a memory effect, i.e., it can continuously display and image without an external electric power supply. As a result, electronic paper has great advantages, in that it can save energy and space. Electronic paper further allows image data to be refreshed with low power consumption. Accordingly, the power needed to refresh the image data, as well as the image data itself, can be supplied to the electronic paper through wireless communications, in similar the way data for non-contact IC cards is refreshed. In addition, electronic paper is thin, light, and flexible. Accordingly, electronic paper has a high degree of flexibility with regard to the areas in which it can be installed. Furthermore, electronic paper having color display capabilities has been developed recently. These advantages make electronic paper suitable for use as a display device installed in gaming machines.

Display devices installed in gaming machines generally must be highly accurate when the games displayed thereon are represented by images, such as the display of symbols on slot machines. This is also true for game data, such as pay tables, that are displayed thereon. However, using electronic paper as a display device, and refreshing the image data thereon through wireless communications, poses high risks of fraud because the image data transmitted to the electronic paper can be accessed and replaced by hackers, and poses high risks of variation of data because wireless communications are generally vulnerable to noises. In those cases, the images displayed on the electronic paper will differ from the images corresponding to the original image data. Furthermore, when electronic paper is installed in locations where there are severe variations in environmental conditions, such as the vibration and temperature variation that occur on the circumference of a stepper reel, the electronic paper may become unstable. In addition, accurate consistency must be maintained between the location of the electronic paper and the images displayed thereon, which is important when electronic paper is used on stepper reels.

In view of the above, it will be apparent to those skilled in the art from this disclosure that there exists a need for an improved gaming machine which uses electronic paper as a display device, which has security functions with regard to the image data displayed by the electronic paper, and which allows the electronic paper to maintain precise display content. This invention addresses this need in the art as well as other needs, which will become apparent to those skilled in the art from this disclosure.

### SUMMARY OF THE INVENTION

A gaming machine according to the present invention comprises a game control unit which controls a game in accordance with a predetermined program; a display unit which includes electronic paper that reproduces an image based on image data; and a display control unit which provides the display unit with predetermined image data depending on the control of the game control unit, and thereby causes the display unit to reproduce an image corresponding to the image data.

In particular, images reproduced on the electronic paper can be easily changed, depending on the types and conditions of games. The gaming machine according to the present invention may further have the following four concrete aspect about its security functions of the image data of the electronic paper.

In a gaming machine according to a first aspect of the present invention, the display control unit includes: a data storage unit in which image data is stored; a command storage unit in which a predetermined command is stored; a communications unit which exchanges commands with the display unit, and then transfers image data from the data storage unit to the display unit; and a communications managing unit which compares a command exchanged between the display and communications units against the command stored in the command storage unit, and then, based on the result of the comparison, permits or prohibits the connection between the display and the communications units.

Further preferably, the command stored in the command storage unit is a valid or invalid command for which the connection is to be allowed or prohibited between the display and communications units, respectively. Thus, the communication managing unit can prohibit any connection between the display and communications units, when the command exchanged between them does not match any of the valid commands, or does match one of the invalid commands. Furthermore, when that connection is prohibited, preferably, the game control unit stops the game promptly, or informs the player of the occurrence of connection error. Thus, the accuracy of the display of the electronic paper is ensured.

In a gaming machine according to a second aspect of the present invention, the display control unit includes a data storage unit in which image data is stored; an encryption unit which reads and encrypts image data from the data storage unit, and a communications unit which externally transmits encrypted image data.

In addition, the display unit includes a decoding unit which decodes data received from the display control unit into image data. Thus, the image data is encrypted and then transferred from the display control unit to the display unit, and accordingly, falsification of the image data during transfer is prevented.

A gaming machine in a third aspect of the present invention includes, in addition to the game control unit, the display unit, and the display control unit: an optical sensor which captures some or all of the image actually reproduced on the electronic paper; and a display monitoring unit which compares the data provided from the optical sensor against the predetermined image data, and then, based on the result of the comparison, detects whether there are any changes in the image actually reproduced on the electronic paper from the image corresponding to the predetermined image data.

Preferably, when the display monitoring unit detects a variation in the above-described image, the display control unit sends new image data to the display unit, and thus causes the display unit to reproduce the image which corresponds to the new image data. Alternatively, the game control unit may stop a game promptly, or may inform the player of the variation of the image. Thus, feedback control using the display monitoring unit ensures accurate agreement between images to be displayed and images actually displayed on the electronic paper.

In a gaming machine according to a fourth aspect of the present invention, the display control unit includes a data storage unit in which image data is stored; and a communications unit which repeatedly transfers image data from the data storage unit to the display unit at fixed intervals.

Thus, the images displayed on the electronic paper are updated periodically, and accordingly, even if an image is changed due to noise or environmental variation, for example, the image will be returned to the proper image in a short period of time. Thus, the accuracy of the display of the electronic paper is ensured.

Preferably, each gaming machine in the above-described four aspects of the present invention further comprises a button used for entering into the machine a parameter or operational information required in the game, and the electronic paper is mounted on the surface of the button. Thereby, the display and decoration of the button can be easily changed, depending on the types and conditions of the game and the function of the button. Accordingly, the machine can easily achieve a further improved ability to amuse a player, further improved operability, and model changes.

Preferably, the above-described gaming machine according to the present invention comprises a reel installed rotatably around a shaft, and the electronic paper is mounted on, or constitutes the circumferential surface of, the reel. Thus, the symbols and decorations displayed on the reel can be changed based on the types and conditions of the games, without replacement of its parts. Accordingly, the machine can easily achieve a further improved ability to amuse a player, and model changes. The above-described gaming machine according to the third aspect of the present invention, in particular, may further comprise a position sensor that detects the rotation angle of the reel, and the display monitoring unit may identify a portion of the predetermined image data to be checked, based on the detected rotation angle. Thus, the proper correspondence between the positions of the reel and the display contents of the electronic paper will be maintained with additional accuracy.

Wireless communications preferably occur between the display and communications units in each gaming machine in the above-described four aspects of the present invention. In other words, each of the display and communications units includes and uses a wireless interface for communications between them. The above-described gaming machine in any aspect according to the present invention ensures high security of the image data transmitted to the electronic paper. Accordingly, the image data has a low risk of being falsified, even if its transmission is performed through wireless communications. Further preferably, electric power is provided to the electronic paper through wireless communications, as well as the image data. Thus, there is no need to be connected between the display unit and the display control unit with wires, and accordingly, the electronic paper can be installed in a wider variety of areas. In particular, when the electronic paper is mounted on a moving component, such as the circumferential surfaces of a reel, there is no need to consider the electric connection at the mechanical joint between the moving component and a fixed component. Accordingly, the structure of the mechanical joint can be simplified.

Alternatively, the display control unit may be separated from the body of the gaming machine, and then used for wireless remote control over the display unit. Thus, for example, the conducting paths between the electronic paper and the display control unit will be simplified.

A gaming system according to the present invention comprises a plurality of gaming machines includes: a game control unit which controls a game in accordance with a predetermined program; and a display unit which includes electronic paper that reproduces an image based on image data; and an image data server which provides each of the gaming machines with image data.

Furthermore, either the gaming machine or the image data server includes a display control unit which provides the display unit with predetermined image data based upon the control of the game control unit, and thereby causes the display unit to reproduce the image corresponding to the image data. Thus, the images reproduced on the electronic paper can be easily changed depending types and conditions of the game. Further preferably, the plurality of the gaming machines can achieve a model change at the same time by using the single image data server. In that case, in particular, downloads of the image data from the image data server to the gaming machines are preferably performed through wireless communications. Here, game programs may be downloaded together with the image data.

A gaming system according to the present invention can further include security functions for the image data of the electronic paper having the following six aspects. Here, the first through fourth aspects are security functions for the image data exchanged between the display control unit and the display unit. On the other hand, the fifth and sixth aspects are security functions for the image data exchanged between the display control unit of each gaming machine and the image data server.

In a gaming system according to the first aspect of the present invention, the display control unit includes a data storage unit in which image data is stored; a command storage unit in which a predetermined command is stored; a communications unit which exchanges a command with the display unit, and then transfers image data from the data storage unit to the display unit; and a communications management unit which compares a command exchanged between the display and communications units against the command stored in the command storage unit, and then, based on the result of the comparison, permits or prohibits the connection between the display and communications units

Further preferably, the command stored in the command storage unit is a valid or invalid command for which the connection is to be allowed or prohibited between the display and communications units, respectively. Thus, the communication management unit can prohibit any connection between the display and communications units, when the command exchanged between them does not match any of the valid commands, or does match one of the invalid commands. Furthermore, when that connection is prohibited, preferably, the game control unit stops the game promptly, or informs the player of the occurrence of a connection error. Thus, the accuracy of the display of the electronic paper is ensured

In a gaming system according to the second aspect of the present invention, the display control unit includes a data storage unit in which image data is stored, an encryption unit which reads and encrypts image data from the data storage unit, and a communications unit which externally transmits encrypted image data; and the display unit includes a decoding unit which decodes data received from the display control unit into image data. Thus, the image data are encrypted and then transferred from the display control unit to the display unit, and accordingly, falsification of the image data during transfer is prevented.

In a gaming system in the third aspect of the present invention, the gaming machine includes an optical sensor which captures some or all of the image actually reproduced on the electronic paper; and a display monitoring unit which compares the data provided from the optical sensor against the predetermined image data, and then, based on the result of the comparison, detects a change in the image actually reproduced on the electronic paper from the image corresponding to the predetermined image data.

Preferably, when the display monitoring unit detects a variation in the above-described image, the display control unit transmits new image data to the display unit, and thus, causes the display unit to reproduce the image which corresponds to the new image data. Alternatively, the game control unit may stop the game promptly, or may inform the player or a manager of the gaming system, of the variation in the image. Thus, feedback control using the display monitoring unit ensures accurate agreement between images to be displayed and images actually displayed on the electronic paper.

In a gaming system according to the fourth aspect of the present invention, the display control unit includes a data storage unit in which image data is stored, and a communications unit which repeatedly transfers image data from the data storage unit to the display unit at fixed intervals. Thus, the images displayed on the electronic paper are updated periodically, and accordingly, even if the image is changed due to noise or environmental variation, the image is returned to the proper image in a short period of time. Thus, the accuracy of the display of the electronic paper is ensured

In a gaming system according to the fifth aspect of the present invention, each of the gaming machines has the above-described display control unit, and the display control unit includes a command storage unit in which a predetermined command is stored; a server interface which exchanges commands with the image data server, and then transfers image data from the image data server to the display unit; and a communications management unit which compares a command exchanged between the image data server and the server interface against the command stored in the command storage unit, and then, based on the result of the comparison, permits or prohibits the connection between the image data server and the server interface.

Further preferably, the command stored in the command storage unit is a valid or invalid command for which the connection is to be allowed or prohibited between the image data server and the server interface, respectively. Thus, the communication management unit can prohibit any connection between the image data server and the server interface, when a command exchanged between them does not match any of the valid commands, or does match one of the invalid commands. Furthermore, when a connection is prohibited, preferably, the game control unit stops the game promptly, or informs the player or the manager of the gaming system, of the occurrence of a connection error. Thus, the accuracy of the display of the electronic paper is ensured. In particular, the manager can promptly understand, through the image data server, which gaming machine has the electronic paper where a display error has occurred.

In a gaming system according to the sixth aspect of the present invention, each of the gaming machines has the above-described display control unit. The image data server includes a data storage unit in which image data is stored; an encryption unit which reads and encrypts image data from the data storage unit; and a communications unit which sends encrypted image data to the display control unit of each of the gaming machines. In addition, the display control unit includes a decoding unit which decodes data received from the image data server into image data. Thus, the image data is encrypted and then transferred from the image data server to the display control unit, and accordingly, falsification of the image data during transfer is prevented.

The gaming machines according to the present invention, as described above, use electronic paper as display devices, and have security functions for the image data of the electronic paper. Thus, display control over the electronic paper is highly resistant to illegal accesses and noise, and thus, the display content of the electronic paper can be maintained with accuracy. Accordingly, the gaming machines according to the present invention are suitable for use with displays that must have a high degree of accuracy, such as the display of symbols and pay tables in a slot machine. The gaming machines according to the present invention can establish a high degree of stability in the display of the electronic paper, even when the electronic paper is installed in areas where environmental conditions, such as vibrations and temperature, severely vary, e.g., on the circumferential surfaces of a stepper reel. This results in an expansion of the areas where the electronic paper can be installed, and therefore, the machines can easily achieve a further improved ability to amuse a player, and further improved operability.

Furthermore, the high security functions of the gaming machine according to the present invention allow the electronic paper to perform secure updating of image data through wireless communications. Thus, there is no need to connect the display unit and the display control unit with wires, and accordingly, the areas where the electronic paper can be installed will further expand. In particular, when the electronic paper is mounted on a moving component, such as a circumferential surfaces of a reel, there is no need to consider an electric connection at the mechanical joint between the moving component and the fixed component. Accordingly, the structure of the mechanical joint can be simplified.

The gaming systems according to the present invention have a high degree of security for the image data of the electronic paper as described above. Thus, a plurality of gaming machines can easily achieve a simultaneous and secure model change by using a common image data server. In particular, the secure download of image data can be performed through wireless communications from the image data server to the gaming machines. Accordingly, the gaming system according to the present invention is suitable for control over many gaming machines in an amusement arcade, a casino, and so on.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view that shows the appearance of a stepper-reel slot machine according to Embodiment 1 of the present invention;

FIG. 2 is a schematic diagram that shows the configuration of a second display unit according to Embodiment 1 of the present invention;

FIG. 3 is a schematic diagram that shows the configuration of the reels and the immediate vicinity thereof according to Embodiment 1 of the present invention;

FIG. 4 is an exploded perspective view of a touch panel according to Embodiment 1 of the present invention;

FIG. 5 is an exploded perspective view of an operation button according to Embodiment 1 of the present invention;

FIG. 6 is an exploded perspective view of a spin button according to Embodiment 1 of the present invention;

FIG. 7 is a block diagram that shows the configuration of a gaming system according to Embodiment 1 of the present invention;

FIG. 8 is a block diagram that shows the configuration of a display control unit and a display unit according to Embodiment 1 of the present invention;

FIG. 9 is a block diagram that shows the configuration of a gaming system according to Embodiment 2 of the present invention; and

FIG. 10 is a block diagram that shows the configuration of a gaming system according to Embodiment 3 of the present invention.

### BEST MODE FOR CARRYING OUT THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Embodiment 1

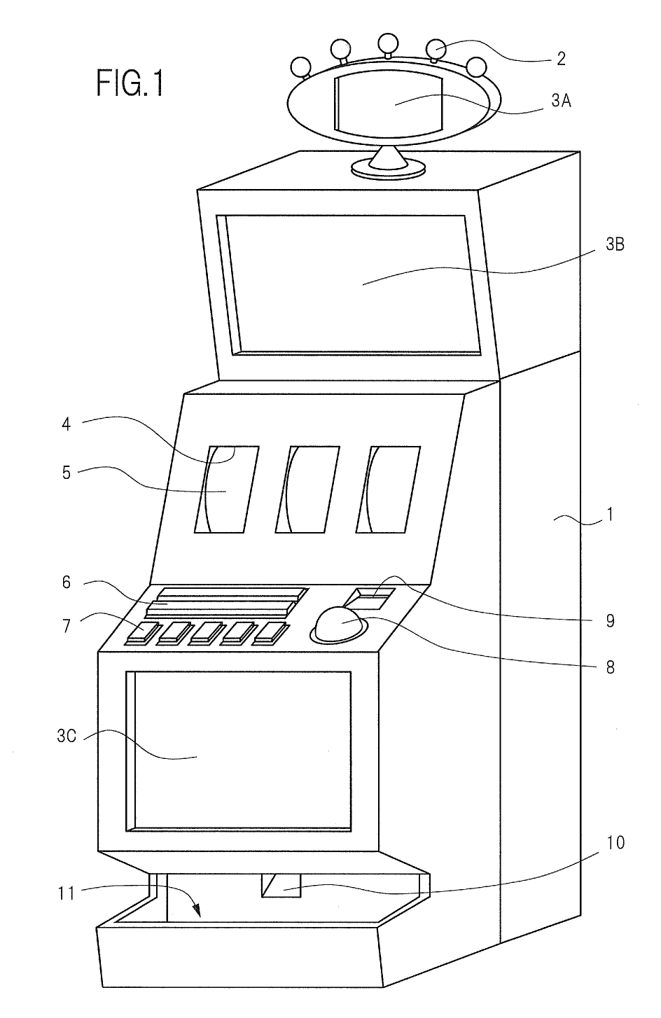

A gaming machine according to Embodiment 1 of the present invention is, preferably, a stepper-reel slot machine installed in a casino as shown in FIG. 1. The components of this slot machine visible from the exterior include a cabinet 1, lamps 2, a first display unit 3A, a second display unit 3B, a third display unit 3C, reels 5, a touch panel 6, operation buttons 7, a spin button 8, a coin inlet 9, a coin outlet 10, and a coin receiver 11. Control units for these components are mounted inside the cabinet 1 (not shown in the figures).

The lamps 2 are illumination lights mainly for use in decoration and visual effects in games; they can blink and/or change brightness and color in specific patterns. The lamps 2 may be mounted on, for example, the top of the cabinet 1, as shown in FIG. 1, and in addition, the front, sides, and rear of the cabinet 1.

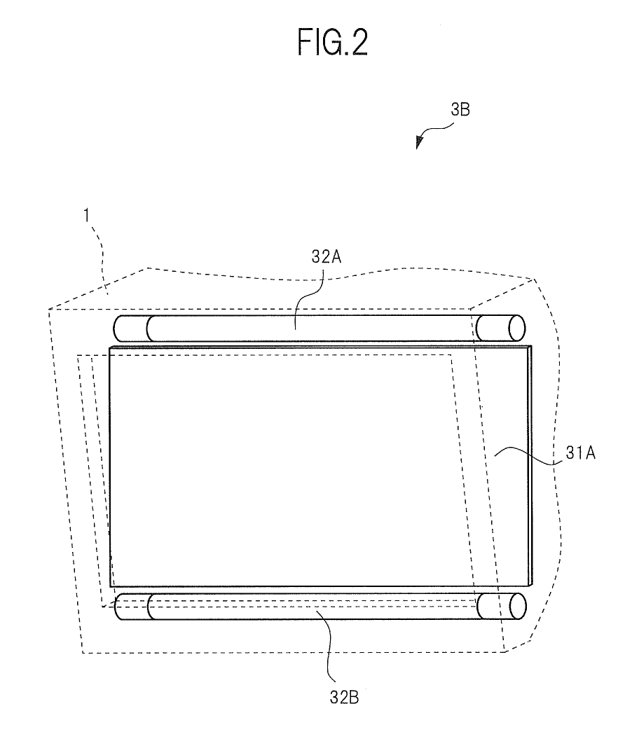

The three display units 3A, 3B, and 3C each receive external image data, and reproduce images which correspond to the image data. The images include, for example, images for use in decoration, such as the image of a logo of a game developer, images for use in advertisements, images for use in visual effects in games and the display of information about games, such as pay tables, illustrations of game content, bets, and the number of credits available. All the three display units 3A, 3B, and 3C have similar structures, and each includes a first electronic paper 31A, and first and second lighting devices 32A and 32B as shown in FIG. 2.

The first electronic paper 31A preferably includes a cholesteric liquid crystal layer, and electrodes sandwiching the layer (not shown in the figures). Furthermore, a drive circuit is installed on the rear or non-display region of the first electronic paper 31A (not shown in the figures). The orientation of the liquid crystal molecules changes periodically in the cholesteric liquid crystal layer. When the drive circuit applies a high voltage between the electrodes, the periodic structure of the cholesteric liquid crystal layer changes depending on the application time, and in particular, the reflectance of visible light will change at a specific wavelength. Furthermore, the once-changed periodic structure will not change again unless a high voltage is again applied between the electrodes. In particular, three kinds of cholesteric liquid crystal layers corresponding to RGB colors are preferably laminated on the first electronic paper 31A (not shown in the figures). The drive circuit receives image data from a display control unit inside the control unit (described below), and controls the voltage between the electrodes of each pixel based on the image data. Thus, the reflectance of each of the RGB cholesteric liquid crystal layers is adjusted at every pixel in the first electronic paper 31A. As a result, a color picture corresponding to the image data is reproduced on the first electronic paper 31A. Note that a microcapsule type may be used in the first electronic paper 31A instead of the above-described cholesteric liquid crystal type. The microcapsule type produces colors when colored particles confined within microcapsules move in response to an electric field.

Once the first electronic paper 31A reproduces a color picture, the paper will maintain the picture for a long period of time without electric power. Accordingly, the first electronic paper 31A requires extremely low power consumption. Furthermore, the low power consumption of the first electronic paper 31A facilitates the miniaturization of its drive circuit (and particularly its power supply). In addition, the first electronic paper 31A itself is extremely thin and flexible. Accordingly, installation of the display units 3A, 3B, and 3C is hardly limited by, for example, surface shapes and the internal size of the cabinet 1. In particular, the display units 3A, 3B, and 3C may be installed in places other than the places shown in FIG. 1, or they may have different sizes and forms from those shown in FIG. 1. As a result, the slot machine according to Embodiment 1 of the present invention has a high degree of flexibility in the design of its appearance.

The first and second lighting devices 32A, 32B are preferably rod-shaped fluorescent lamps (see FIG. 2), or alternatively, may be rod- or board-shaped LED lighting devices. The two lighting devices 32A and 32B brightly illuminate the display region of the first electronic paper 31A, preferably from above and below the first electronic paper 31A. Here, either of the two lighting devices 32A and 32B may be omitted when the luminance one is high enough. Furthermore, the two lighting devices 32A and 32B may be provided at other positions different from the positions shown in FIG. 2, for example, on the right and left sides of the first electronic paper 31A. The lights of the two lighting devices 32A and 32B reflected in (the cholesteric liquid crystal layer of) the first electronic paper 31A clarify the color picture displayed on the first electronic paper 31A. The first electronic paper 31A may have a translucent structure and lighting devices installed behind the first electronic paper 31A, instead of the reflective structure shown in FIG. 2. In that case, the lights of the lighting devices penetrating (the cholesteric liquid crystal layer of) the first electronic paper 31A clarify the color picture displayed on the first electronic paper 31A.

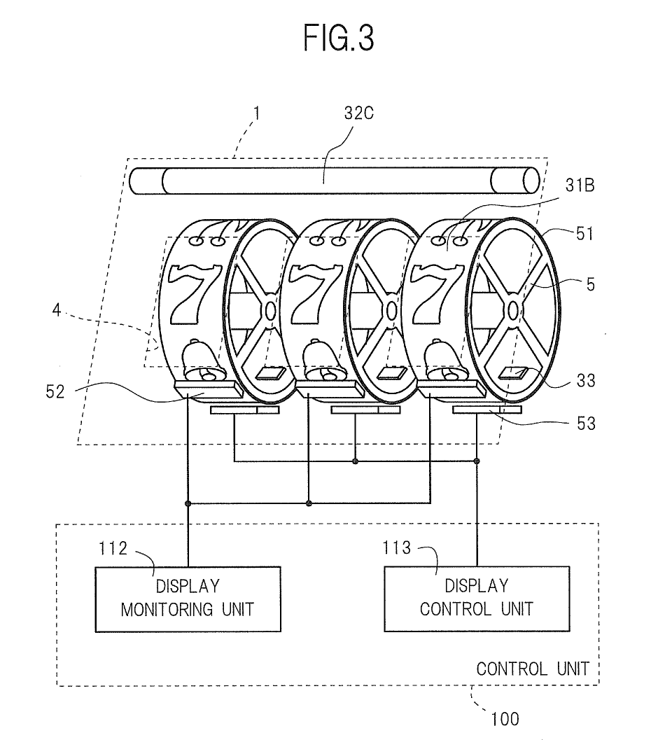

The display window 4 is comprised of a plurality of holes provided in front of the cabinet 1, as shown in FIG. 1. A portion of the circumferential surface of the reels 5 can be seen through the display window 4 from the exterior of the cabinet 1. Each reel 5 is a member rotatable around its center axis, and preferably, three or more reels 5 having the same form are coaxially installed inside the cabinet 1, as shown in FIG. 3. Each reel 5 is, preferably, a stepper reel. In other words, the rotation angle and speed of each reel 5 can be controlled by a stepping motor (not shown in the figures). A second electronic paper 31B and its drive circuit 33 are mounted on each reel 5. A third lighting device 32C, optical sensors 52, and wireless communications units 53 are installed around the reel 5.

The second electronic paper 31B is similar to the first electronic paper 31A, and is mounted on or forms the circumferential surface 51 of each reel 5. Here, since the second electronic paper 31B is flexible, that the whole of the circumferential surface 51 of the reel 5 is preferably covered by the single electronic paper.

The drive circuits 33 are preferably mounted on the inner surfaces of the reels 5. In contrast, the wireless communications units 53 are fixed on the cabinet 1, preferably in the vicinity of the circumferential surfaces 51 of the reels 5. Each drive circuit 33 has a built-in wireless interface, and thereby performs wireless communication with the wireless communications units 53. The wireless communications units 53 connect the display control unit 113 inside the control unit 100 to the drive circuits 33 via wireless communication. Here, the wireless interfaces of the drive circuits 33 and the wireless communications units 53 are preferably based on the ISO/IEC 14443 standard (the international standard for contactless IC cards). Thus, the drive circuits 33 receive both image data and electric power from the wireless communications units 53. Alternatively, the wireless interfaces of the drive circuits 33 and the wireless communications units 53 may be based on Bluetooth™, UWB (ultra wideband wireless communications), wireless LAN (IEEE 802.11x), or IrDA (infrared-ray communications). In that case, the drive circuits 33 preferably are equipped with one or more batteries as their power source.

The drive circuits 33 further controls the voltage between electrodes in every pixel in the second electronic paper 31B, based on the image data and electric power received from the wireless communications unit 53. As a result, the color picture corresponding to the image data is reproduced on the second electronic paper 31B. The image data is transmitted from the display control unit 113, and then is transferred to the drive circuit 33 through the wireless communications unit 53. The image data includes, in particular, image data which shows a predetermined line of symbols. Accordingly, the line of symbols is displayed on the second electronic paper 31B (see FIG. 3). Different symbols appear in the display windows 4, depending on the rotation angles of the reels 5.

The third lighting device 32C is preferably a rod-shaped fluorescent lamp, or alternatively, may be a rod- or board-shaped LED lighting device. The third lighting 32C brightly illuminates the front of the circumferential surfaces 51 of the reels 5, and particularly the display region of the second electronic paper 31B, from above the reels 5. Here, the third lighting device 32C may be provided at a different position from the position shown in FIG. 3, for example, below, or on the right or left hand side of the reels 5. The light of the third lighting device 32C reflected on the second electronic paper 31B clarify the color pictures displayed on the second electronic paper 31B. The second electronic paper 31B may have a translucent structure and a lighting device mounted on inside of each the reels 5, instead of the reflective structure shown in FIG. 3. In that case, the light of the lighting devices penetrating the second electronic paper 31B clarify the color pictures displayed on the second electronic paper 31B.

The optical sensors 52 are preferably line sensors that are fixed on the cabinet 1 in the vicinity of the circumferential surfaces 51 of the reels 5. The optical sensors 52 may be alternatively micro-CCD (or CMOS) cameras. The optical sensors 52 detect light reflected from the second electronic paper 31B, and thereby captures images displayed at specific places on the circumferential surfaces 51 of the reels 5. The optical sensors 52 are connected to a display monitoring unit 112 inside the control unit 100, and send the captured image data to the display monitoring unit 112.

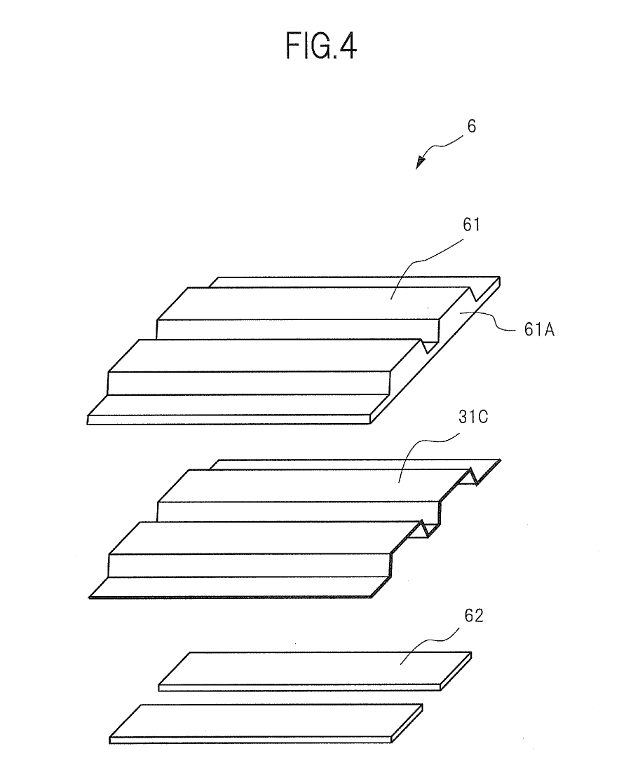

A touch panel 6, operation buttons 7, and a spin button 8 are devices which enable the player to input various kinds of information, as shown in FIG. 1. The touch panel 6 has a structure in which a cover 61, a third electronic paper 31C, and a touch sensor 62 are preferably laminated, as shown in FIG. 4. The cover 61 preferably includes a transparent and flexible plastic material, and includes bulges 61A which facilitate operation by a player. The cover 61 protects the third electronic paper 31C from, in particular, dust and excessive pressing force of the player.

The third electronic paper 31C is similar to the first electronic paper 31A. The third electronic paper 31C is flexible enough to stick to the entire bottom of the cover 61 and to fit the concave and convex portions of the cover 61. The drive circuit of the third electronic paper 31C (not shown in the figures) receives image data from the display control unit inside the control unit, and based on the image data, reproduces a color picture on the third electronic paper 31C. The image displayed on the third electronic paper 31C can be seen through the cover 61.

The touch sensor 62 is preferably comprised of pressure sensors, and is installed below the bulge 61A of the cover 61. Here, the transparent touch sensor 62 may be placed on the third electronic paper 31C. When a player touches the cover 61, the touch sensor 62 detects a tiny deformation of the cover 61 or a tiny change in stress, and passes information about the detected position to an operating unit inside the control unit (described below). The operating unit interprets the information based upon on the image displayed on the third electronic paper 31C. For example, a keyboard and a numeric keypad are displayed on the third electronic paper 31C, thereby allowing a player enter characters and numerals through the touch panel 6.

Lighting devices may be mounted in the vicinity of or above the cover 61 in FIG. 4. Furthermore, when the third electronic paper 31C has a translucent structure and the touch sensor 62 is transparent, instead of the reflective structure shown in FIG. 4, lighting devices may be installed below the third electronic paper 31C. In that case, the lights of the lighting devices penetrating the third electronic paper 31C clarify the color picture displayed on the third electronic paper 31C.

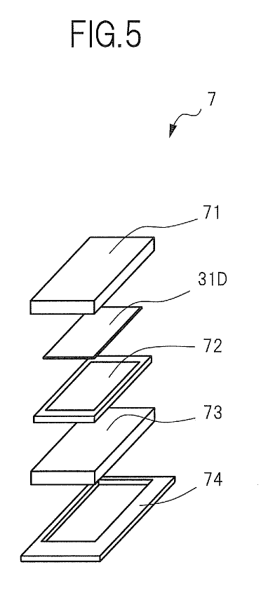

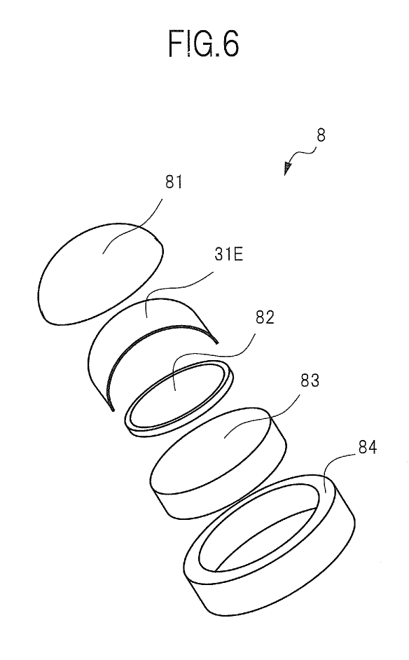

The operation buttons 7 and the spin button 8 are lamp buttons, which include light-emitting devices which light up when the buttons are pushed, as shown in FIGS. 5 and 6. A player uses the operation buttons 7, for example, in order to enter a bet. A player uses the spin button 8 in order to cue the reels 5 for the start of rotation. The operation buttons 7 each have a laminated structure comprising, preferably, a cover 71, fourth electronic paper 31D, a light-emitting device 72, a button switch 73, and a frame 74, as shown in FIG. 5. Similarly, the spin button 8 has a laminated structure comprising, preferably, a cover 81, fifth electronic paper 31E, a light-emitting device 82, a button switch 83, and a frame 84, as shown in FIG. 6.

The covers 61 and 71 preferably consist of transparent plastic material. The covers 61 and 71 protect the fourth and fifth electronic paper 31D and 31E from excessive pressing force by the player, and from dust. Both the fourth and fifth electronic paper 31D and 31E are similar to the first electronic paper 31A. However, both the fourth and fifth electronic paper 31D and 31E have a translucent structure, in contrast to the first electronic paper 31A with the reflective structure. The fifth electronic paper 31E is flexible enough to stick on the inner surface of the cover 81 and to fit the round shape of the cover 81. The drive circuits of the electronic paper 31D and 31E receive image data from display control units inside the control unit, and then reproduce the color pictures corresponding to the image data on the respective electronic paper 31D and 31E. The images can be seen through the covers 71 and 81. The light-emitting devices 72 and 82 are preferably board-shaped LEDs, or alternatively, may by slim light-emitting devices such as an organic LED. The light-emitting devices 72 and 82 are mounted below the fourth and fifth electronic paper 31D and 31E, respectively. The lights of the light-emitting devices 72 and 82 penetrate the fourth and fifth electronic paper 31D and 31E to clarify the color pictures displayed on the electronic paper 31D and 31E, respectively.

The switch buttons 73 and 83 are preferably push switches which are turned on and off at every time a player pushes the covers 71 and 81, respectively. The operating unit inside the control unit (described below) are informed when the switch buttons 73 and 83 are turned on and off. The frame 74 of the operation button 7 fixes, on the cabinet 1, the laminated body comprising the cover 71, the fourth electronic paper 31D, the light-emitting device 72, and the button switch 73. Similarly, the frame 84 of the spin button 8 fixes, on the cabinet 1, a laminated body comprising the cover 81, the fifth electronic paper 31E, the light-emitting device 82, and the button switch 83.

A player inserts coins in the coin inlet 9 shown in FIG. 1. Here, the coins may be either real currency or medals only allowed to be used for slot machines. The inserted coins are used to place bets in a game. Coins equivalent to the credits which the player receives as a prize for winning a game are discharged from the coin outlet 10, and then stored in the coin receiver 11. See FIG. 1.

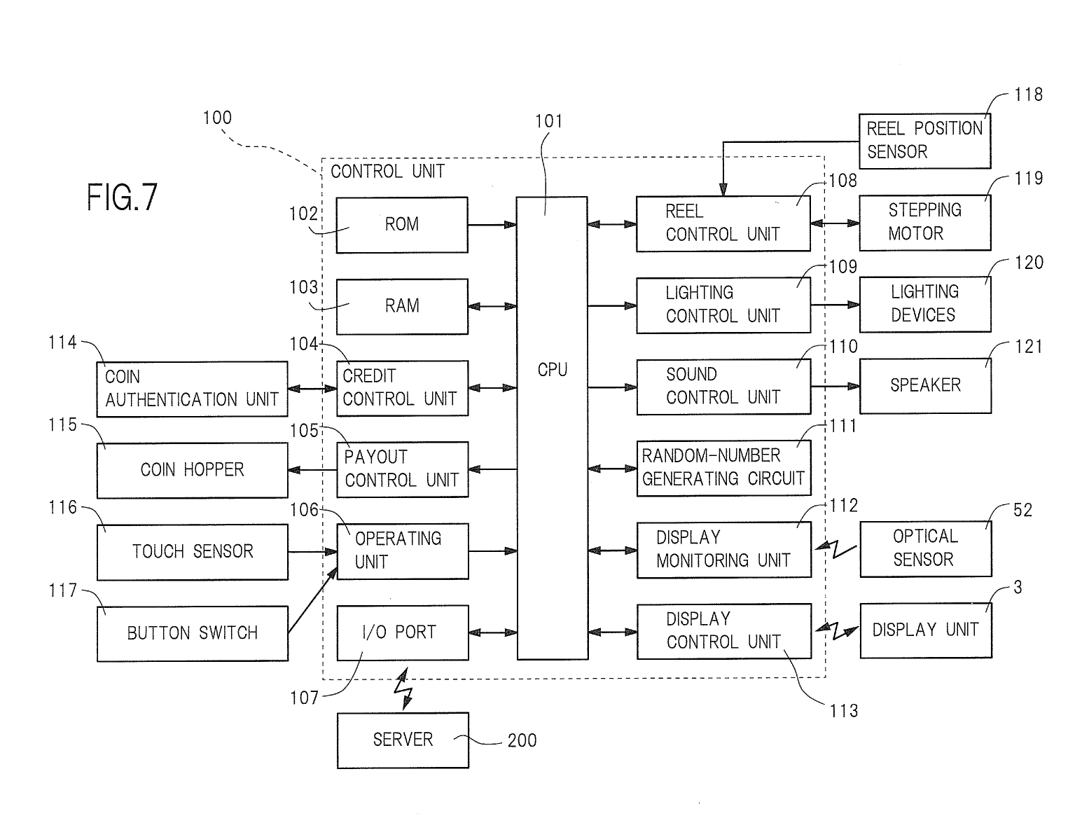

The above-described components are controlled by the control unit inside the cabinet 1. See FIG. 7. The control unit 100 preferably includes a CPU 101, a ROM 102, a RAM 103, a credit control unit 104, a payout control unit 105, an operating unit 106, an I/O port 107, a reel control unit 108, a lighting control unit 109, a sound control unit 110, a random-number generating circuit 111, the display monitoring unit 112, and the display control unit 113.

The CPU 101, the ROM 102, and the RAM 103 constitute the core of the control unit 100. The ROM 102 and the RAM 103 store various programs such as game programs, game content data such as pay tables, parameters required for games, and image data for the electronic paper 31A-E such as symbol lines to be displayed on the circumferential surfaces 51 of the reels 5. The ROM 102 preferably includes a rewritable ROM, and in particular, stores the game programs and the image data even after power is turned off. The RAM 103 is used as a temporary storage for the data processed by the CPU 101. The CPU 101 runs programs stored in the ROM 102 and the RAM 103, and processes data stored in them in an appropriate manner. Thus, the CPU 101, the ROM 102, and the RAM 103 control games as a game control unit, while controlling the following components of the slot machine, thereby ensuring their respective, specific functions.

The credit control unit 104 controls a coin authentication unit 114 installed inside the cabinet 1. The coin authentication unit 114 is connected to the coin inlet 9 (see FIG. 1), and then identifies or authenticates the coins inserted in the coin inlet 9. The credit control unit 104 calculates the amount of the coins inserted, or the credits, based on the result of the authentication, for example. The CPU 101 totals the number of credits, and stores the total amount in the RAM 103 as data which indicates the credits of the player.

The payout control unit 105 controls a coin hopper 115 installed inside the cabinet 1. The coin hopper 115 accommodates a large number of coins, which include the coins inserted in the coin inlet 9. The coin hopper 115 selects a given number of coins from the stored coins, and then discharges the selected coins from the coin outlet 10. The payout control unit 105 controls the discharging operation of the coin hopper 115 (in particular, the number of discharged coins).

The operating unit 106 analyzes the position data detected by a touch sensor 116 mounted on the cabinet 1 (for example, the touch sensor 62 included in the touch panel 6, cf. FIGS. 1 and 4), and then converts the position data to corresponding data such as numerical values and characters. The operating unit 106 further monitors the on-off state of a button switch 117 mounted on the cabinet 1 (for example, the button switches 73 and 83 included in the operation buttons 7 and the spin button 8, respectively, cf. FIGS. 1, 5 and 6), and then instructs the CPU 101 to use the functions corresponding to the buttons in response to the buttons being turned on and off (for example, the setting of predetermined bets and the start of the rotation of the reels 5).

The I/O port 107 is used in communications between the control unit 100 and a server 200. Here, preferably, one server 200 is connected to several slot machines, i.e., the server 200 and the several slot machines constitute a single gaming system. The server 200 manages the several slot machines collectively, and in particular, provides the several slot machines with the same game programs and image data. Preferably, a wireless LAN (IEEE 803.11) connects the I/O port 107 and the server 200, or alternatively, a cable LAN (IEEE 803.3) may be used.

The reel control unit 108 controls a stepping motor 119, and thereby adjusts the rotation angle and speed of the reels 5. In particular, the reel control unit 108 uses one or more reel position sensors 118 in the detection of the actual rotation angle and speed of each of the reels 5, and then performs feedback control based on the detected values. Thus, the rotation of the reels 5 is controlled with high precision. Here, the reel position sensor 118 preferably uses a magnetic sensor including a Hall device, or alternatively, may use a rotary encoder.

The lighting control unit 109 causes lighting devices 120 mounted inside and outside the cabinet 1 to blink and/or change brightness and color in specific patterns. The lighting devices 120 include, for example, the lamps 2, the first-third lighting devices 32A, 32B, and 32C, and the light-emitting devices 72 and 82. See FIGS. 1-3, 5, and 6. The sound control unit 110 controls a speaker 121 installed inside the cabinet 1, and thereby causes it to generate voice announcements and sound effects.

The random-number generating circuit 111 preferably generates random numbers equal to the number of reels 5, and provides the random numbers to the CPU 101, in response to the push of the spin button 8 (cf. FIG. 1). The random numbers are used in a lottery process, as described below.

The display monitoring unit 112 analyzes the images captured by the optical sensor 52, and thereby identifies the image which is actually displayed at a specific point on the circumferential surface 51 of the reel 5. See FIG. 3. Here, the display monitoring unit 112 may use the actual rotation angle of the reel 5 detected by the reel position sensor 118 in determining the accurate display position of the identified image. The display monitoring unit 112 further compares the identified image against the image to be displayed at the specific point on the circumferential surface 51 of the reel 5, based on the image data for the second electronic paper 31B mounted on the reel 5. When the latter image differs from the former image beyond a specific degree, the display monitoring unit 112 preferably informs the display control unit 113 of this difference.

The display control unit 113 controls display units 3 which include, for example, the three display units 3A, 3B, 3C; the second electronic paper 31B and the drive circuits 33 mounted on the reels 5; the third electronic paper 31C included in the touch panel 6; the fourth electronic paper 31D included in the operation button 7; and the fifth electronic paper 31E included in the spin button 8. See FIGS. 1-6. The display control unit 113, in particular, provides specific image data to the display units 3 in response to the game control of the CPU 101, and thereby causes the display units 3 to reproduce the images corresponding to the image data.

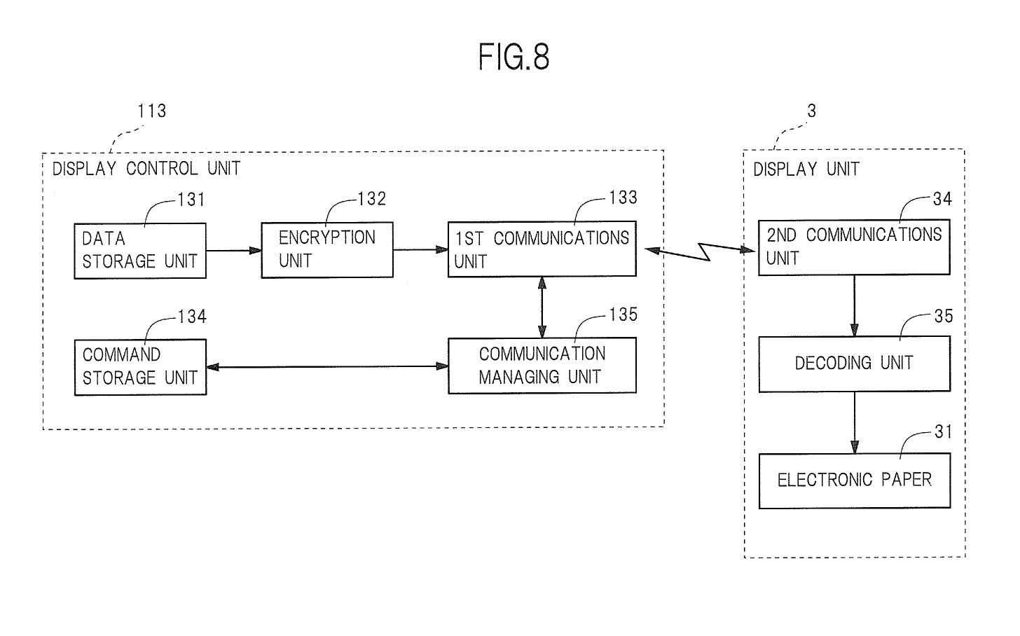

The display control unit 113 preferably includes a data storage unit 131, an encryption unit 132, a first communications unit 133, a command storage unit 134, and a communication managing unit 135. See FIG. 8. The data storage unit 131 stores the image data to be transferred to the display units 3. The data storage unit 131 may serve as a memory exclusive to the display control unit 113, or double as the RAM 103. The encryption unit 132 reads and encrypts image data from the data storage unit 131.

The first communications unit 133 exchanges commands and establishes a connection with the display unit 3, and then transfers the image data encrypted by the encryption unit 132 to the display unit 3. Further preferably, the first communications unit 133 uses a wireless interface (for example, the wireless communications unit 53, cf. FIG. 3), in the wireless connection with the display unit 3. Here, the wireless communications may be based on ISO/IEC 14443, Bluetooth™, UWB, IEEE 802.11x or IrDA. Alternatively, wires and cables may connect the first communications unit 133 and the display unit 3. The first communications unit 133, further preferably, repeats the transfer of the same image data from the data storage unit 131 to the display unit 3 at predetermined intervals. Here, the intervals are preferably on the order of the maximum period of the rotation of the reel 5.

The command storage unit 134 stores predetermined commands selected from amongst the commands exchanged between the first communications unit 133 and the display unit 3. Preferably, the commands stored in the command storage unit 134 are valid or invalid commands for which a connection is to be allowed or prohibited between the first communications unit 133 and the display unit 3, respectively. Here, the validity of the commands is preferably determined based upon whether the commands include a specific ID for each of the first communications unit 133 and the display unit 3. Alternatively, when common characteristics shared by the invalid commands are known, data for use in the detection of these characteristics may be stored in the command storage unit 134.

The communication managing unit 135 compares the commands exchanged between the first communications unit 133 and the display unit 3 against the commands stored in the command storage unit 134. Here, the comparison process may include the detection process of the common characteristics shared by the invalid commands. When the result of the comparison shows that the command exchanged between the first communications unit 133 and the display unit 3 is invalid, the communication managing unit 135 prohibits the connection between the first communications unit 133 and the display unit 3. When the commands are valid, the communication managing unit 135 allows the connection between the first communications unit 133 and the display unit 3. The communication managing unit 135 further preferably informs the CPU 101 of the prohibition of the connection between the first communications unit 133 and the display unit 3.

The display unit 3 is equivalent to one of, for example, the first to third display units 3A, 3B, and 3C; the second electronic paper 31B and its drive circuit 33 mounted on the reel 5; the third electronic paper 31C included in the touch panel 6; the fourth electronic paper 31D included in the operation button 7; and the fifth electronic paper 31E included in the spin button 8. The display unit 3 preferably includes electronic paper 31, a second communications unit 34, and a decoding unit 35. See FIG. 8. The electronic paper 31 is similar to the first to fifth electronic paper 31A-31E. The second communications unit 34 is a similar wireless interface to, for example, the wireless interface included in the drive circuit 33 installed in the reel 5 (cf. FIG. 3), and is wirelessly connected to the first communications unit 133 included in the display control unit 113. The decoding unit 35 decodes the data that the second communications unit 34 receives from the display control unit 113, to image data.

Using the above-described components, the slot machine causes a game to progress as follows. A player inserts coins in the coin inlet 9. See FIG. 1. At that time, the credit control unit 104 counts the inserted coins, and then provides the CPU 101 with credit data, or data that shows credits, or the total count of the inserted coins. See FIG. 7. The CPU 101 stores the credit data in the RAM 102.

The player next uses the touch panel 6 and the operation buttons 7, and thereby enters a bet. See FIG. 1. The operating unit 106 identifies the data that shows the bet, based on the position information detected by the touch panel 6 and the pressing of the operation buttons 7, and then sends the data to the CPU 101. The CPU 101 processes the credit data stored in the RAM 103, and thereby reduces the credits of the player by the bet. See FIG. 7. After that, the operating unit 106 detects the push of the spin button 8 by the player, and informs the CPU 101 of the detection. At that time, the CPU 101 instructs the reel control unit 108 to start rotation of the reels 5, the reel control unit 108 starts the stepping motor 119, and then the reels 5 start rotation. Thus, the symbols seen through the display window 4 begin to change. See FIG. 3.

When the spin button 8 is pushed, the following lottery process is performed, in parallel with the start process of rotation of the reel 5. First, the random-number generating circuit 111 operates and generates random numbers equal to the number of reels 5. Furthermore, the random numbers are used in the selection of the rotation angles of the reels 5 and symbols to be seen through the display window 4 when the reels 5 stop. Next, the combination of the selected symbols is compared against the specific combinations that show wins. The result of the comparison determines whether the player wins.

When a predetermined time has elapsed from the push of the spin button 8, the reel control unit 108 causes the reels 5 to stop at the rotation angles selected in the lottery process. Thus, the combination of the symbols selected in the lottery process appears in the display window 4. The CPU 101 further performs a payout process when the player wins. More specifically, the CPU 101 processes the credit data stored in the RAM 103, and thereby adds the amount of the award to the credits of the player. When the player pushes the touch panel 6 or the operation buttons 7 to require payout of the coins equivalent to the credits, the CPU 101 operates the payout control unit 105, and thereby discharges the coins equivalent to the credits of the player from the coin hopper 115 through the coin outlet 10 to the coin receiver 11.

The CPU 101 further operates the lighting control unit 109 and the sound control unit 110 to produce their respective effects, in parallel with the game control. For example, the lighting control unit 109 controls the following lighting devices to blink and/or change brightness and color in specific patterns: the lamps 2; the lighting devices 32A and 32B included in the display units 3A, 3B, and 3C; the lighting device 32C that illuminates the reels 5; and the light-emitting devices 72 and 82 included in the operation buttons 7 and the spin button 8, respectively. The sound control unit 110 provides specific sound effects from the speaker 121. In particular, the flashing and color-changing patterns of the lighting devices and the sound effects are preferably changed, depending on the conditions of the game.

Moreover, the CPU 101, in parallel with the game control, controls the display control unit 113 that changes the displayed contents on the display unit 3, depending on the conditions of the game. When the credits and bets of the player are displayed on either of the first to third display units 3A, 3B, and 3C, for example, their displays are updated, depending on the new coins inserted in the coin inlet 9, the entry of the bet by the push of the touch panel 6 and the operation buttons 7, and the game results. When the odds and winning probabilities change based upon the win history, for example, the pay table displayed on either of the first to third display units 3A, 3B, and 3C is updated, and the displays on the touch panel 6 and the operation buttons 7 are updated. This helps the player notice the change, and accordingly, the slot machine can improve its ability to amuse the player and improve its operability. Furthermore, the display of the electronic paper 31A-31L may be modified, for example, based upon the state of the rotating reels 5. This allows various visual effects to be devised in collaboration with the lighting effects of the lighting control unit 109, and therefore, the slot machine can further improve its ability to amuse the player.

When the display control unit 113 changes the display of the electronic paper 31 included in the display unit 3, the new image data will be transferred in the following secure manner. See FIG. 8.

First, at the start of the connection-establishing procedure between the first communications unit 133 included in the display control unit 113 and the second communications units 34 included in the display unit 3, predetermined commands are exchanged between the two communications units 133 and 34. During the procedure, the communication managing unit 135 compare the actually exchanged commands against the commands stored in the command storage unit 134. When the result of the comparison shows that the exchanged command is invalid, the communication managing unit 135 prohibits the connection between the two communications units 133 and 34, and then informs the CPU 101 of the prohibition. Thus, the CPU 101 promptly stops the game. In addition, the CPU 101 may cause, for example, some or all of the lamps 2 to blink in specific patterns, or one or all of the three display units 3A, 3B, and 3C to reproduce predetermined images. Accordingly, the player and persons in the vicinity of the slot machine promptly notice the occurrence of the connection error. Moreover, through the I/O port 107, the server 200 may be informed of the occurrence of the connection error. See FIG. 7. Thus, no connection is established between two communications units 133 and 34 unless valid commands are exchanged between them. This avoids any unauthorized access and any transfer of wrong image data due to noise in the display unit 3.

Second, image data is encrypted and then transferred between the display control unit 113 and the display unit 3. Accordingly, falsification of the image data during transfer is prevented. As described above, the new image data is securely transferred between the display control unit 113 and the display unit 3. This ensures the accurate display of the electronic paper 31.

Third, the display control unit 113 ensures the accurate agreement between the symbol to be displayed and symbols actually displayed, for example, on the second electronic paper 31B mounted on the circumferential surface 51 of the reel 5, by the following two methods.

In the first method, the display control unit 113 uses the display monitoring unit 112 in monitoring the symbols actually displayed on the second electronic paper 31B. See FIG. 3. When detecting a symbol obviously different from the predetermined symbols through the display monitoring unit 112, the display control unit 113 sends new image data to the drive circuit 33, and thereby causes the circuit to reproduce on the second electronic paper 31B the accurate symbol corresponding to the new image data. Alternatively, the CPU 101 may promptly stop the game, and then inform the player, people in the vicinity of the slot machine, and the server 200 of the changes in the symbols.

In the second method, the first communications unit 133 included in the display control unit 113 repeats the transfer of the image data corresponding to the symbol line to the drive circuit 33 at specific intervals. Thus, the symbols displayed on the second electronic paper 31B are frequently updated. Even if the symbols change due to, for example, unauthorized access, noise, vibrations, and temperature changes, such periodic updates, that is, the refreshing process, soon eliminate the changes and then reproduce the correct symbols.

Thus, the display control unit 113 ensures accurate agreement between the symbols to be displayed and the symbols actually displayed on the second electronic paper 31B, using the feedback control with the display monitoring unit 112 and the refreshing process. A similar feedback control and refreshing process may be performed for the other electronic paper except the second electronic paper 31B.

The change in the image of the electronic paper 31 included in the display unit 3 results from the update of its image data. Accordingly, when the images of the electronic paper 31A-31E are to be changed due to, for example, a model change, a large number of the slot machines preferably download new image data, as well as a new game program, from the same server 200. See FIG. 7. Thus, no portions of the slot machines, such as the control panels and cabinets, are required to be replaced. Accordingly, a model change for many slot machines can be promptly performed.

The slot machine according to Embodiment 1 of the present invention includes the built-in display control unit 113. Alternatively, the display control unit 113 may be separated from the body of the slot machine, and then perform wireless remote control over the display unit 3. This can eliminate, for example, the wiring between the wireless communications unit 53 and the display control unit 113 shown in FIG. 3.

### Embodiment 2

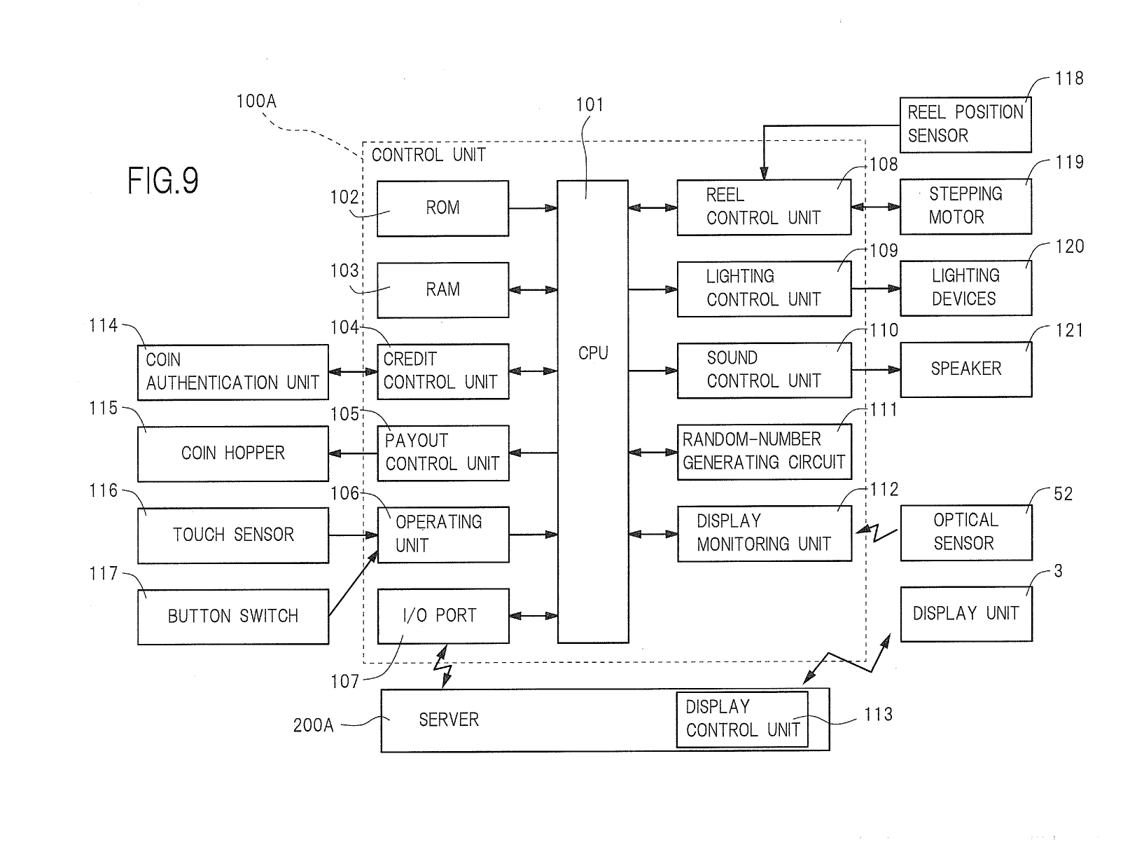

A gaming system according to Embodiment 2 of the present invention is similar to the gaming system according to Embodiment 1 (cf. FIG. 7), and is preferably installed in a casino. The gaming machines included in the system are preferably stepper-reel slot machines similar to the gaming machines according to Embodiment 1. See FIG. 1. Furthermore, one server is connected to each group of several slot machines, similar to Embodiment 1. However, the display control unit is not installed in each slot machine, but in the server in the gaming system according to Embodiment 2, in contrast to the gaming system according to Embodiment 1. See FIG. 9. In FIG. 9, the components similar to the components of the gaming system according to Embodiment 1 shown in FIG. 7 are marked with the same reference symbols as the reference symbols shown in FIG. 7. Furthermore, a description of the similar components can be found above in the description of Embodiment 1.

The server 200A is connected to a control unit 100A of each slot machine through its I/O port 107. Here, a wireless LAN (IEEE 803.11) preferably connects the server 200A and the I/O port 107. Alternatively, a cable LAN (IEEE 803.3) may be used. One server 200A is connected to, preferably, each group of several slot machines, and collectively manages the several slot machines. In particular, the server 200A provides the same game programs and image data to the several slot machines.

The server 200A includes a display control unit 113. The display control unit 113 has an internal configuration that is quite similar to that of the display control unit 113 according to Embodiment 1. See FIG. 8. The display control unit 113, in particular, conducts wireless communication directly with the display unit 3, not using the communications between the server 200A and the I/O port 107. However, because of a generally long distance between the server 200A and each slot machine, the wireless communications between the display control unit 113 and the display unit 3 is, preferably, based on a wireless communication standard for middle range, such as Bluetooth™, UWB, wireless LAN (IEEE 802.11x) and IrDA. A description of other components of the display control unit 113 can be found in the description of Embodiment 1 and FIG. 8.

New image data are transferred in a secure manner, similarly to Embodiment 1, when the display control unit 113 changes the display on the electronic paper 31 included in the display unit 3. See FIG. 8. More specifically, the following two security processes are performed. First, the communication managing unit 135 checks that valid commands are exchanged between the first and second communications units 133 and 34 included in the display control unit 113 and the display unit 3, respectively. When the exchanged command is invalid, the communication managing unit 135 prohibits the connection of the two communications units 133 and 34, and then the game is interrupted. Furthermore, the player, people in the vicinity of the slot machine, and the server 200A are informed of the connection prohibition. Second, image data is encrypted and transferred between the display control unit 113 and the display unit 3. These two security processes achieve the secure transfer of new image data between the display control unit 113 and the display unit 3, thereby ensuring the accurate display of the electronic paper 31.

The display control unit 113 further ensures the accurate agreement between images to be displayed and images actually displayed on the electronic paper 31, using the following two security processes, similarly to Embodiment 1. See FIG. 9. First, the display control unit 113 uses the display monitoring unit 112 in the feedback control over the display of the electronic paper 31. When the display of the electronic paper 31 is different from a specific image, the display control unit 113 updates the image data held by the display unit 3. Alternatively, the CPU 101 may promptly stop a game, and then inform the player, people in the vicinity of the slot machine, and the server 200A of the change in the image. Second, the display control unit 113 repeats the transfer of the same image data to the display unit 3 (the refreshing process). The feedback control and the refreshing process always maintain high consistency between images to be displayed and images actually displayed on the electronic paper 31.

Only the renewal of image data is required for the change of image on the electronic paper 31 included in the display unit 3. Accordingly, when the image of the electronic paper 31 is to be changed, for example, due to a model change, new image data is downloaded from the display control unit 113 included in the common server 200A, preferably to several slot machines. Thus, the gaming system according to Embodiment 2 can promptly perform a model change for a large number of slot machines, similar to the gaming system according to Embodiment 1.

### Embodiment 3

A gaming system according to Embodiment 3 of the present invention is similar to the gaming system according to Embodiment 1 (cf. FIG. 7), and is preferably installed in a casino. The gaming machines included in the system are preferably stepper-reel slot machines similar to the gaming machines according to Embodiment 1. See FIG. 1. Furthermore, one server is connected to each group of several slot machines, similar to Embodiment 1. Descriptions of the configuration of the gaming system and slot machines according to Embodiment 3 can be found above in the description of Embodiment 1 and FIGS. 1-7.

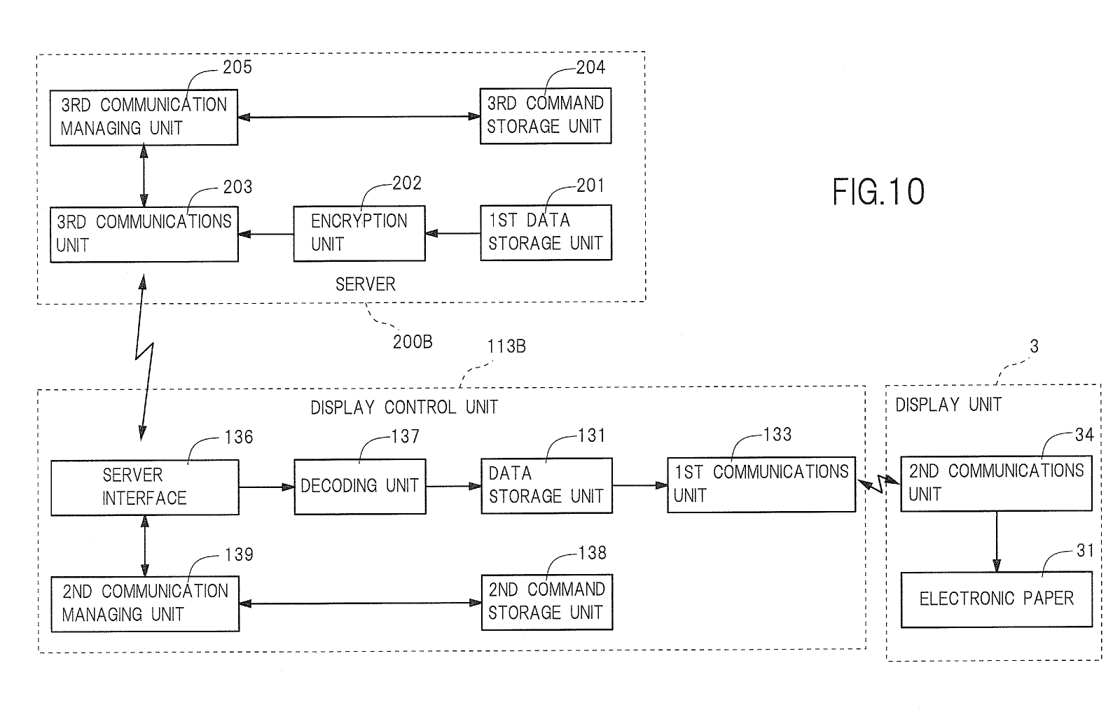

The gaming system according to Embodiment 3 comprises the following security functions for the transfer of image data between the server and the display control units inside the slot machines (cf. FIG. 10), in contrast to the gaming system due to Embodiment 1. In FIG. 10, the components similar to the components of the gaming system according to Embodiment 1 shown in FIG. 8 are marked with the same reference symbols as the reference symbols shown in FIG. 8. Furthermore, the description of the similar components can be found above in the description of Embodiment 1.

A display control unit 113B includes, preferably, a server interface 136, a decoding unit 137, a second command storage unit 138, and a second communication managing unit 139, in addition to the data storage unit 131 and the first communications unit 133, similar to those of the display control unit 113 according to Embodiment 1 (cf. FIG. 8). See FIG. 10. The server interface 136 exchanges commands with the server 200B through the I/O port 107 (cf. FIG. 7), and thereby establishes a connection and receives data from the server 200B. The decoding unit 137 decodes the data that the server interface 136 received from the server 200B to the corresponding image data. The decoded image data is then stored in the data storage unit 131 as image data to be transferred to the display unit 3.

The second command storage unit 138 stores specific commands, which are, preferably, valid or invalid commands for which a connection is to be allowed or prohibited between the server 200B and the server interface 136, respectively. Here, the validity of the commands are preferably determined whether the commands include a specific ID for each of the server 200B and the server interface 136. Alternatively, when common characteristics shared by the invalid commands are known, the data for use in the detection of the characteristics may be stored in the second command storage unit 138.

The second communication managing unit 139 compares the commands exchanged between the server 200B and the server interface 136 against the commands stored in the second command storage unit 138. Here, the comparison process may include the detection process of the common characteristics shared by the invalid commands. When the comparison result shows that the command exchanged between the server 200B and the server interface 136 is invalid, the second communication managing unit 139 prohibits the connection between the server 200B and the server interface 136. In other cases, the second communication managing unit 139 allows the connection between the server 200B and the server interface 136. The second communication managing unit 139 further preferably informs the CPU 101 of the prohibition of the connection between the server 200B and the server interface 136.

The server 200B includes, preferably, a second data storage unit 201, an encryption unit 202, a third communications unit 203, a third command storage unit 204, and a third communication managing unit 205. See FIG. 10. The second data storage unit 201 stores the image data to be transferred to the display unit 3. The encryption unit 202 reads and encrypts image data from the data storage unit 201.

First, the third communications unit 203 conducts communication with the I/O port 107 of each slot machine (cf. FIG. 7). Here, a wireless LAN (IEEE 803.11) preferably connects the third communications unit 203 and the I/O port 107. Alternatively, a cable LAN (IEEE 803.3) may be used for the connection. Next, the third communications unit 203 exchanges commands and establishes a connection with the server interface 136 through the I/O port 107. Furthermore, the unit 203 transfers the image data encrypted by the encryption unit 202 to the server interface 136.

The third command storage unit 204 stores specific commands, which are, preferably, valid or invalid commands for which a connection is to be allowed or prohibited between the third communications unit 203 and the server interface 136, respectively. Here, the validity of the commands is preferably determined by whether the commands include a specific ID for each of the third communications unit 203 and the server interface 136. Alternatively, when common characteristics shared by the invalid commands are known, the data for use in the detection of the characteristics may be stored in the third command storage unit 204.

The third communication managing unit 205 compares the commands exchanged between the third communications unit 203 and the server interface 136 against the commands stored in the third command storage unit 204. Here, the comparison process may include the detection process of the common characteristics shared by the invalid commands. When the comparison result shows that the command exchanged between the third communications unit 203 and the server interface 136 is invalid, the third communication managing unit 205 prohibits the connection between the third communications unit 203 and the server interface 136. In other cases, the third communication managing unit 205 allows the connection between the third communications unit 203 and the server interface 136. The third communication managing unit 205 further preferably informs the CPU 101 in the slot machine of the prohibition of the connection between the third communications unit 203 and the server interface 136.

The following two security processes ensure that the display control unit 113B of each slot machine downloads from the server 200B, new image data to be provided for the electronic paper 31 included in the display unit 3, in a secure manner. First, the second and third communication managing units 139, 205 check that valid commands are exchanged between the server interface 136 included in the display control unit 113B and the third communications unit 203 included in the server 200B, respectively. When the exchanged command is invalid, either of the second and third communication managing units 139, 205 prohibits the connection of the server interface 136 and the third communications unit 203. Furthermore, the CPU 101 of the slot machine is informed of the prohibition of the connection, and then interrupts the game. In addition, the player, persons in the vicinity of the slot machine, and the server 200B are informed of the prohibition of the connection. Second, image data is encrypted and transferred between the server interface 136 and the third communications unit 203. These two security processes achieve the secure download of image data from the server 200B to the display control unit 113B, thereby ensuring the accurate display on the electronic paper 31.

As described above, the gaming machine according to the present invention uses electronic paper as display devices, and has security functions for the image data of the electronic paper.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A gaming machine, comprising:
a game control unit configured to control a game in accordance with a predetermined program;
a display unit comprising electronic paper, and configured to reproduce an image based on image data; and
a display control unit configured to supply said display unit with predetermined image data based upon the control of said game control unit, and thereby cause said display unit to reproduce the image corresponding to the image data;
said display control unit comprising:
a data storage unit configured to store image data;
a command storage unit configured to store a predetermined command;
a communications unit configured to exchange commands with said display unit, and transfer image data from said data storage unit to said display unit; and
a communications management unit configured to compare a command exchanged between said display and communications units against the command stored in said command storage unit, and then, based on the result of the comparison, permit or prohibit the connection between said display and communications units.

2. A gaming machine according to claim 1, further comprising a button configured to input a parameter or operational data required in said game, and
wherein said electronic paper is mounted on the surface of said button.

3. A gaming machine according to claim 1, further comprising a reel rotatably installed around a shaft; and
wherein said electronic paper is mounted on, or comprises the circumferential surface, of said reel.

4. A gaming machine according to claim 1, wherein said display unit and said communications unit are configured to wirelessly communicate with each other.

5. A gaming machine, comprising:
a game control unit configured to control a game in accordance with a predetermined program;
a display unit comprising electronic paper, and configured to reproduce an image based on image data; and
a display control unit configured to provide said display unit with predetermined image data based on the control of said game control unit, and thereby cause said display unit to reproduce the image corresponding to the image data;
said display control unit comprising:
a data storage unit configured to store image data;
an encryption unit configured to read and encrypt image data from said data storage unit, and
a communications unit configured to externally transmit encrypted image data; and
wherein said display unit comprises a decoding unit configured to decode data received from said display control unit into image data.

6. A gaming machine according to claim 5, further comprising a button configured to input a parameter or operational data required in said game, and
wherein said electronic paper is mounted on the surface of said button.

7. A gaming machine according to claim 5, further comprising a reel rotatably installed around a shaft, and
wherein said electronic paper is mounted on, or comprises the circumferential surface of, said reel.

8. A gaming machine according to the claim 5, wherein said display unit and said communications unit are configured to wirelessly communicate with each other.

9. A gaming machine, comprising:
a game control unit configured to control a game in accordance with a predetermined program;
a display unit comprising electronic paper, and configured to reproduce an image based on image data;
a display control unit configured to provide said display unit with predetermined image data based on the control of said game control unit, and thereby cause said display unit to reproduce the image corresponding to the image data;
an optical sensor configured to capture some or all of the image actually reproduced on said electronic paper; and
a display monitoring unit configured to compare the data provided from said optical sensor against said predetermined image data, and based on the result of the comparison, detect a change in the image actually reproduced on said electronic paper from the image corresponding to said predetermined image data.

10. A gaming machine according to claim 9, further comprising a button configured to input a parameter or operational data required in said game, and
wherein said electronic paper is mounted on the surface of said button.

11. A gaming machine according to the claim 9, further comprising a reel rotatably installed around a shaft, and
wherein said electronic paper is mounted on, or comprises the circumferential surface of, said reel.

12. A gaming machine according to claim 11, further comprising a position sensor configured to detect the rotation angle of said reel; and
wherein said display monitoring unit is configured to identify a portion of said predetermined image data to be checked, based on the detected rotation angle.

13. A gaming machine, comprising:
a game control unit configured to control a game in accordance with a predetermined program;
a display unit comprising electronic paper, and configured to reproduce an image based on image data;
a display control unit configured to provide said display unit with predetermined image data based on the control of said game control unit, and thereby cause said display unit to reproduce the image corresponding to the image data;
said display control unit comprising:
a data storage unit configured to store image data; and
a communications unit configured to repeatedly transfer image data from said data storage unit to said display unit at fixed intervals.

14. A gaming machine according to claim 13, further comprising a button configured to input a parameter or operational data required in said game, and
wherein said electronic paper is mounted on the surface of said button.

15. A gaming machine according to claim 13, further comprising a reel rotatably installed around a shaft, and
wherein said electronic paper is mounted on, or comprises the circumferential surface of, said reel.

16. A gaming machine according to claim 13, wherein said display unit and said communications unit are configured to wirelessly communicate with each other.

17. A gaming system, comprising:
a plurality of gaming machines, each gaming machine comprising:
a game control unit configured to control a game in accordance with a predetermined program; and
a display unit comprising electronic paper, and configured to reproduce an image based on image data; and
an image data server which provides each of said gaming machines with image data;
either of said gaming machine and said image data server further comprising a display control unit configured to provide said display unit with predetermined image data depending on the control of said game control unit, and thereby cause said display unit to reproduce the image corresponding to the image data; and
said display control unit comprising:
a data storage unit configured to store image data;
a command storage unit configured to store a predetermined command;
a communications unit configured to exchange a command with said display unit, and transfer image data from said data storage unit to said display unit; and
a communications management unit configured to compare a command exchanged between said display and communications units against the command stored in said command storage unit, and then, based on the result of the comparison, permit or prohibit the connection between said display and communications units.

18. A gaming system, comprising:
a plurality of gaming machines comprising:
a game control unit configured to control a game in accordance with a predetermined program; and
a display unit comprising electronic paper, and configured to reproduce an image based on image data; and
an image data server configured to provide each of said gaming machines with image data;
either of said gaming machine and said image data server further comprising a display control unit configured to provide said display unit with predetermined image data based on the control of said game control unit, and thereby cause said display unit to reproduce the image corresponding to the image data;
said display control unit comprising:
a data storage unit configured to store image data,
an encryption unit configured to read and encrypt image data from said data storage unit, and
a communications unit configured to externally transmit encrypted image data; and
said display unit comprising a decoding unit configured to decode data received from said display control unit into image data.

19. A gaming system, comprising:
a plurality of gaming machines, each gaming machine comprising:
a game control unit configured to control a game in accordance with a predetermined program; and
a display unit comprising electronic paper, and configured to reproduce an image based on image data; and
an image data server configured to provide each of said gaming machines with image data;
either of said gaming machine and said image data server further comprising a display control unit configured to provide said display unit with predetermined image data based on the control of said game control unit, and thereby cause said display unit to reproduce the image corresponding to the image data; and
said gaming machine comprising:
an optical sensor configured to capture some or all of the image actually reproduced on said electronic paper; and
a display monitoring unit configured to compare the data provided from said optical sensor against said predetermined image data, and then, based on the result of the comparison, detect a change in the image actually reproduced on said electronic paper from the image corresponding to said predetermined image data.

20. A gaming system, comprising:
a plurality of gaming machines, each gaming machine comprising:
a game control unit configured to control a game in accordance with a predetermined program; and
a display unit comprising electronic paper, and configured to reproduce an image based on image data; and
an image data server which provides each of said gaming machines with image data;
either of said gaming machine and said image data server further comprising a display control unit configured to provide said display unit with predetermined image data based on the control of said game control unit, and thereby cause said display unit to reproduce the image corresponding to the image data; and
said display control unit comprising:
a data storage unit configured to store image data, and
a communications unit configured to repeatedly transfer image data from said data storage unit to said display unit at fixed intervals.

21. A gaming system, comprising:
a plurality of gaming machines, each gaming machine comprising:
a game control unit configured to control a game in accordance with a predetermined program;
a display unit comprising electronic paper, and configured to reproduce an image based on image data; and
a display control unit configured to provide said display unit with predetermined image data based on the control of said game control unit, and thereby cause said display unit to reproduce the image corresponding to the image data; and
an image data server configured to provide each of said gaming machines with image data;
said display control unit comprising:
a command storage unit configured to store a predetermined command;
a server interface configured to exchange commands with said image data server, and then transfer image data from said image data server to said display unit; and
a communications management unit configured to compare a command exchanged between said image data server and said server interface against the command stored in said command storage unit, and then, based on the result of the comparison, permit or prohibit the connection between said image data server and said server interface.

22. A gaming system, comprising:
a plurality of gaming machines, each gaming machine comprising:
a game control unit configured to control a game in accordance with a predetermined program;
a display unit comprising electronic paper, and configured to reproduce an image based on image data; and
a display control unit configured to provide said display unit with predetermined image data based on the control of said game control unit, and thereby cause said display unit to reproduce the image corresponding to the image data; and
an image data server configured to provide each of said gaming machines with image data;
said image data server comprising:
a data storage unit configured to store image data;
an encryption unit configured to read and encrypt image data from said data storage unit; and
a communications unit configured to transmit encrypted image data to said display control unit of each of said gaming machines; and
wherein said display control unit comprises a decoding unit configured to decode data received from said image data server into image data.
